(19) United States
(12) Patent Application Publication
(10) Pub. No.: US 2018/0214251 A1
(43) Pub. Date: Aug. 2, 2018

(54) ELEMENT FOR DENTAL BRACKET

(71) Applicant: Allnorth Solutions Oy, Helsinki (FI)

(72) Inventor: Markus Aronen, Helsinki (FI)

(21) Appl. No.: 15/422,940

(22) Filed: Feb. 2, 2017

(51) Int. Cl. A61C 7/12; A61C 7/30; A61C 7/28

(52) U.S. Cl. CPC A61C 7/125; A61C 7/28; A61C 7/303

(57) ABSTRACT

An element for a dental bracket includes a ligature loop; a cover section having a first side and a second side, the second side of the cover section faces the ligature loop; and a bridge section connecting the ligature loop and the cover section, where the ligature loop and the cover section are arranged to pivot with respect to each other.

### TECHNICAL FIELD

The present disclosure relates generally to orthodontics; and more specifically, to an element for a dental bracket.

### BACKGROUND

In the recent past, there has been a prevalent need for orthodontics in order to improve overall dental health and fix difficulties with speech, chewing and biting. With advancements in dental technologies, orthodontic treatments have become quite common. Conventionally, orthodontic appliances comprise braces, used to align and straighten teeth and improve the appearance of the person. Braces usually consist of dental brackets glued to a surface of the teeth and an archwire attached to the dental brackets using ligature loops.

Generally, the dental bracket, glued to the outer surface of the tooth, is frequently pushed against an inner lip tissue of the person. Typically, the dental brackets and the ligature loops may include rough exterior edges or sides. Therefore, contact between such dental brackets and ligature loops with the inner lip tissue may cause discomfort to the person and may lead to bleeding. Further, people with overbite may face several inconveniences while using the conventional dental brackets as upper teeth of the person may bite straight down into the dental brackets on the lower teeth. This may further cause the brackets to fall off. Additionally, the aesthetic appearance of such conventional dental brackets is not very appealing.

In order to address above problems, wax or a plastic rail may be used to smoothen the dental brackets and achieve protection from the physical injury to the inner lip tissue. However, such protective measures may be unhygienic and may provide a temporary solution against any discomfort or injury to the inner lip tissue. Further, to make the dental brackets aesthetically pleasant coloured ligature rings may be used along with the dental brackets. However, such ligature rings do not benefit those who want to downplay or hide the appearance of the braces. Further, use of such ligature rings does not provide any protection to the inner lip tissue.

Therefore, in light of the foregoing discussion, there exists a need to overcome the aforementioned drawbacks associated with conventional dental brackets.

### SUMMARY

The present disclosure seeks to provide an element for a dental bracket. The present disclosure seeks to provide a solution to the existing problem, of attachment, discomfort and aesthetic unpleasantness, associated with a dental bracket. An aim of the present disclosure is to provide a solution that overcomes at least partially the problems encountered in prior art, and provides a protective element for a dental bracket.

In one aspect, an embodiment of the present disclosure provides an element for a dental bracket, the element comprises:
a ligature loop;
a cover section having a first side and a second side, wherein the second side of the cover section faces the ligature loop; and
a bridge section connecting the ligature loop and the cover section,
   wherein the ligature loop and the cover section are arranged to pivot with respect to each other.

In another aspect, an embodiment of the present disclosure provides a dental braces comprising at least one element, described herein above.

Embodiments of the present disclosure substantially eliminate or at least partially address the aforementioned problems in the prior art, and enables better attachment, comfort and aesthetic pleasantness for a dental bracket.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1 and 2 are rear perspective views of an element for a dental bracket, in accordance with various embodiments of the present disclosure; and

FIGS. 3, 4 and 5 are schematic illustrations of an element for a dental bracket in used states, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides an element for a dental bracket, the element comprises:
a ligature loop;
a cover section having a first side and a second side, wherein the second side of the cover section faces the ligature loop; and
a bridge section connecting the ligature loop and the cover section,
   wherein the ligature loop and the cover section are arranged to pivot with respect to each other.

In another aspect, an embodiment of the present disclosure provides a dental braces comprising at least one element, described herein above.

The present disclosure provides an element for a dental bracket. The element described in the present disclosure includes a cover section for the dental bracket. Therefore, the cover section prevents the dental bracket from rubbing or scratching the inner lip tissue when a force or pressure is applied on the outer surface of the lip. Moreover, the element of the present disclosure allows decorative designs and patterns to be displayed on an outer surface of the cover section, which may appeal to both younger and older demographic. Further, the bridge section of the element is structurally strong which provides protection against overbite. Additionally, the cover section can be pivotably moved away with respect to the dental bracket of the element, which allows cleaning of teeth and the dental bracket without removing the cover section. The the ligature loop and the cover section are indeed arranged to pivot with respect to each other. This can be achieved in various manners. For example, the structure and/or material of the ligature loop can be such that it bends and allows the pivoting. Alternatively, the bridge section can have such a structure and/or material that it bends to allow pivoting. A yet further option is that the cover section is such that it bends to allow pivoting. In an embodiment, a dental bracket is an orthodontic appliance adapted to be attached to a tooth of a person. Specifically, the dental bracket may be attached to the tooth of the person for aligning and/or straightening the tooth. More specifically, the dental bracket may be attached to the tooth by orthodontic adhesives (for example, dental cement). Further, the dental bracket may be attached to either an upper tooth or a lower tooth of the person. According to an embodiment, the dental bracket may comprise at least two tabs (also referred to as ‘hooks’, ‘wings’, or ‘prongs’) forming at least one slot therebetween. An archwire may be inserted (or threaded) though the at least one slot in order to apply pressure for aligning and/or straightening the tooth of the person.

An element for the dental bracket comprises a ligature loop. Specifically, the element is attached to the dental bracket using the ligature loop of the element. The term “ligature loop” in the present application refers to a loop-like element that is arranged around the bracket. In an embodiment, the ligature loop may be an orthodontic appliance for mounting the archwire on the dental bracket. Specifically, the ligature loop holds the archwire into the at least one slot formed between the at least two tabs of the dental bracket. More specifically, the ligature loop may be a ring-like orthodontic appliance adapted to securely conform to shape of the dental bracket. Particularly, the ligature loop may be shaped to conform (or fit snugly) around the at least two tabs of the dental bracket, thereby, securing the archwire in place. Examples of shape of the ligature loop include, but are not limited to, circular, oval, or rectangular.

According to an embodiment of the present disclosure, the ligature loop may be made of an elastic material, a plastic material, or any combination thereof. In an example, the ligature loop may be made of the elastic material including, but are not limited to, rubber, silicone, and elastically-deformable plastics. In such example, the elastic material may be stretched to snugly fit around the at least two tabs of the dental bracket for mounting and securing the archwire in place. In another example, the ligature loop may be made of the plastic material including, but not limited to, metals, alloys (such as stainless steel), and plastically-deformable plastics. In such example, the plastic material may be placed around the dental bracket, and shaped manually or using sterile dental tools/equipment, to securely conform to the at least two tabs of the dental bracket.

Further, the element for the dental bracket comprises a cover section. The cover section has a first side and a second side, wherein the second side of the cover section faces the ligature loop. Therefore, the element, and particularly, the first side of the cover section may be positioned adjacent to an inner lip tissue of the person. In an example, the first side of the cover section may have a flat surface. In another example, the first side of the cover section may have a slightly curved surface.

In an embodiment, the cover section may be a protective covering (or sheathing) for the dental bracket. Specifically, the cover section may rest against the dental bracket. More specifically, the cover section may prevent the dental bracket from damaging the inner lip tissue of the person, thereby protecting the inner tissue. Simultaneously, the cover section may also protect the dental bracket from damage due to contaminants.

According to an embodiment, the cover section may be made of a material selected from a group comprising plastics, rubber, and silicone. Specifically, the material for making the cover section may have strength to endure mechanical stress that may be caused by use of the cover section. Further, the material for making the cover section may be resistant to daily wear- and tear, thereby, being suitable for long-term use.

In an embodiment, the cover section may have one of a circular, an oval and a polygonal shape. Specifically, such shape of the cover section may at least completely envelop (or cover) the dental bracket. Optionally, at least one vertex of the polygonal shape may be rounded. In an example, the cover section may have a rectangular shape with four rounded vertices. In another example, the cover section may have a circular shape. In yet another example, the cover section may have a triangular shape.

According to an embodiment, the cover section may be configured to have a size larger than the dental bracket and smaller or equal to the tooth supporting the dental bracket. Specifically, the size of the cover section may be larger than the dental bracket to completely envelop (or cover) the dental bracket, thereby preventing the dental bracket from being in contact with, and damaging the inner lip tissue of the person. Further, the size of the cover section may be smaller or equal to the tooth supporting the dental bracket to prevent discomfort to the person. In an embodiment, the cover section may be adapted for displaying patterns and/or motifs thereon. Specifically, the patterns and/or motifs may be displayed on the front side of the cover section. In another embodiment, text (such as initials of name of the person) may be displayed on the cover section.

Optionally, the cover section may have a colour similar to that of the tooth supporting the dental bracket. For example, the cover section may have white or off-white colour. Alternatively, the cover section may have a colour dissimilar to that of the tooth supporting the dental bracket. For example, the cover section may have colours such as pink, green, blue, and so forth.

The element for the dental bracket further comprises a bridge section connecting the ligature loop and the cover section. This bridge section may also connect the ligature loop and the cover section pivotably to each other. In an embodiment, the bridge section may form a hinge-like connection between the ligature loop and the cover section. In such embodiment, the cover section may be pivotally moved away with respect to the dental bracket (and specifically, the ligature loop) for creating a space therebetween. The space may allow a cleaning means, such as a tooth brush, to be received therein for enabling cleaning of at least one of the dental bracket, the ligature loop, and a portion of the tooth not covered by the dental bracket. Further, the cleaning means may be used for cleaning the cover section and the bridge section.

In an embodiment, the bridge section may be configured to have a shape of an L-shaped bend, or a rectangular flat structure. In another embodiment, the bridge section may be configured to have a shape of a curved structure.

According to an embodiment, the element may be attached to a dental bracket supported by a lower tooth of the person. In such embodiment, the bridge section may protect the dental bracket attached to the lower tooth in case of overbite condition. Specifically, the bridge may provide protection to the lower tooth from overlap of an upper tooth positioned above the aforementioned lower tooth. More specifically, the bridge section may prevent dislocation or damage (due to the overbite condition) to the dental bracket attached to the lower tooth. Optionally, in such embodiment, width of the bridge section may be greater than width of a bridge section of an element to be attached to a dental bracket for the upper tooth of the person.

According to an embodiment, the ligature loop and the cover section may be spaced apart and arranged to be parallel to each other. Specifically, the bridge section may have shape and size suitable to space apart and arrange the ligature loop and the cover section parallel to each other. Further, the ligature loop and the cover section may be parallel to each other in an unused state of the ligature loop. However, in use, the ligature loop may be shaped around the dental bracket to securely conform to the at least two tabs of the dental bracket to keep the archwire in place. In such instance, the ligature loop may be shaped such that the ligature loop is not parallel to the cover section.

According to another embodiment, the ligature loop and the cover section may be spaced apart and arranged at an angle to each other. Specifically, the angle between the ligature loop and the cover section may be such that the cover section at least completely envelops (or covers) the dental bracket for preventing the dental bracket from damaging the inner lip tissue of the person. Further, the angle may be such that the arrangement of the ligature loop and the cover section may be comfortable for the person. Examples of the angle between the cover ligature loop and the cover section include, but are not limited to, 5 degrees, 10 degrees, 15 degrees, 20 degrees, 25 degrees, and 30 degrees.

In an embodiment, each of the cover section and the bridge section may comprise a first end and a second end, and wherein the first end of the bridge section is attached to the first end of the cover section and the second end of the bridge section is attached to the ligature loop. Specifically, the first ends of the cover section and the bridge section are attached to allow pivotable movement of the cover section with respect to the dental bracket.

In another embodiment, the cover section may comprise a first protrusion, the first protrusion protruding from the second side of the cover section at the second end of the cover section. Specifically, the first protrusion may be configured to align the cover section with a bottom side (or bottom edge) of the dental bracket, when the cover section rests against the dental bracket. More specifically, the first protrusion may support the bottom side of the dental bracket. According to an embodiment, the first protrusion may be used to pivotably move the cover section with respect to the dental bracket.

In yet another embodiment, the bridge section may comprise a second protrusion, the second protrusion protruding from the bridge section and perpendicular to the ligature loop. Specifically, the second protrusion may be configured to align the cover section on an upper side of the dental bracket by pushing the cover section against a surface of the tooth supporting the bracket. Therefore, the second protrusion may press the cover section firmly towards a joint of the dental bracket and the surface of the tooth. Furthermore, the second protrusion may be arranged at an angle with respect to the ligature loop, wherein the angle is different from 90 degrees. For example, the angle may be about 70, 75, 80, 85, 90, 95, 100, 105 or 110 degrees.

In one example, the second protrusion may protrude from a middle part of the bridge section. In such example, if the bridge section has a shape of an L-shaped bend, the bridge section, along with the second protrusion may collectively have a T-shape.

According to an embodiment, a dental braces may comprise at least one element according to the aforementioned embodiments. Specifically, the at least one element may be attached to at least one dental bracket for aligning and/or straightening teeth of the person. More specifically, one dental bracket may be attached to one tooth of the person. Optionally, the dental braces may further comprise an archwire adapted to be mounted on the dental bracket with the ligature loop. Specifically, the archwire may be inserted through slots of each dental bracket of the dental braces. Further, the ligature loop may be used to mount the archwire on the dental bracket by securely conforming to shape of the dental bracket.

### DETAILED DESCRIPTION OF THE DRAWINGS

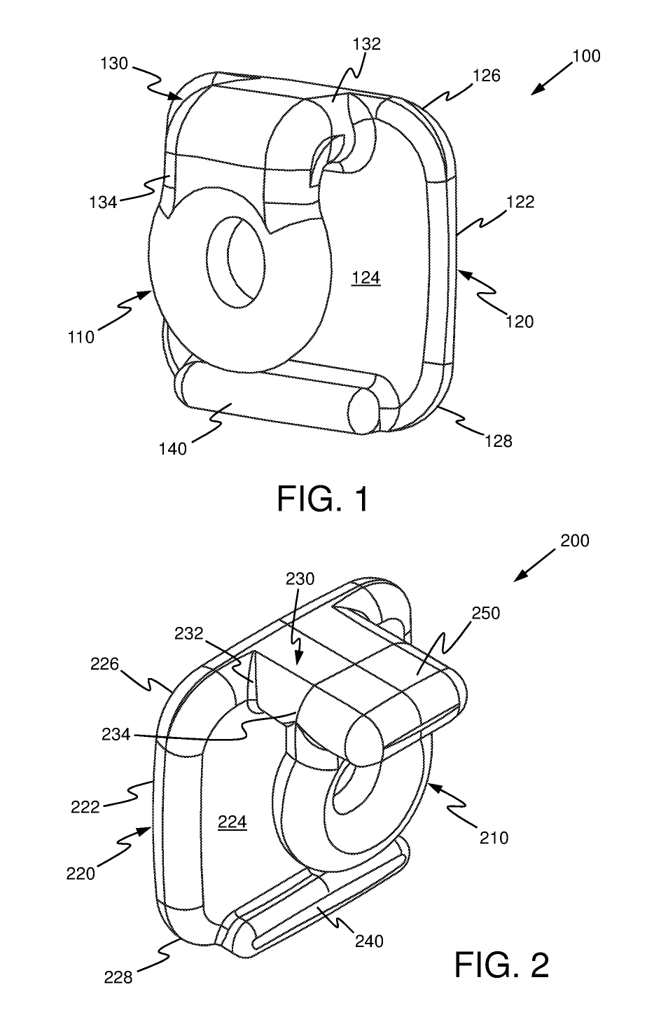

FIG. 1 is a rear perspective view of an element 100 for a dental bracket (not shown), in accordance with an embodiment of the present disclosure. As shown, the element 100 includes a ligature loop 110, a cover section 120 and a bridge section 130. The cover section 120 includes a first side 122 and a second side 124; and the second side 124 is spaced apart and faces the ligature loop 110. The bridge section 130 connects the ligature loop 110 and the cover section 120 pivotably to each other. In the present embodiment, the bridge section 130 is configured to have a shape of an L-shaped bend. Each of the cover section 120 and the bridge section 130 comprises a first end, such as first ends 126, 132, and a second end, such as second ends 128, 134, respectively. Further, the first end 132 of the bridge section 130 is attached to the first end 126 of the cover section 120, and the second end 134 of the bridge section 130 is attached to the ligature loop 110. Moreover, as shown, the cover section 120 includes a first protrusion 140 protruding from the second side 124 of the cover section 120 at the second end 128 of the cover section 120.

FIG. 2 is a rear perspective view of an element 200 for a dental bracket (not shown), in accordance with another embodiment of the present disclosure. As shown, the element 200 includes a ligature loop 210, a cover section 220 and a bridge section 230. The cover section 220 includes a first side 222 and a second side 224; and the second side 224 is spaced apart and faces the ligature loop 210. The bridge section 230 connects the ligature loop 210 and the cover section 220 pivotably to each other. In the present embodiment, the bridge section 230 is configured to have a shape of a flat rectangular structure. Each of the cover section 220 and the bridge section 230 comprises a first end, such as first ends 226, 232, and a second end, such as second ends 228, 234, respectively. Further, the first end 232 of the bridge section 230 is attached to the first end 226 of the cover section 220, and the second end 234 of the bridge section 230 is attached to the ligature loop 210. Moreover, as shown, the cover section 220 includes a first protrusion 240 protruding from the second side 224 of the cover section 220 at the second end 228 of the cover section 220. As shown, the bridge section 230 of the present embodiment also includes a second protrusion 250. The second protrusion 250 protrudes from the bridge section 230 and perpendicular to the ligature loop 210.

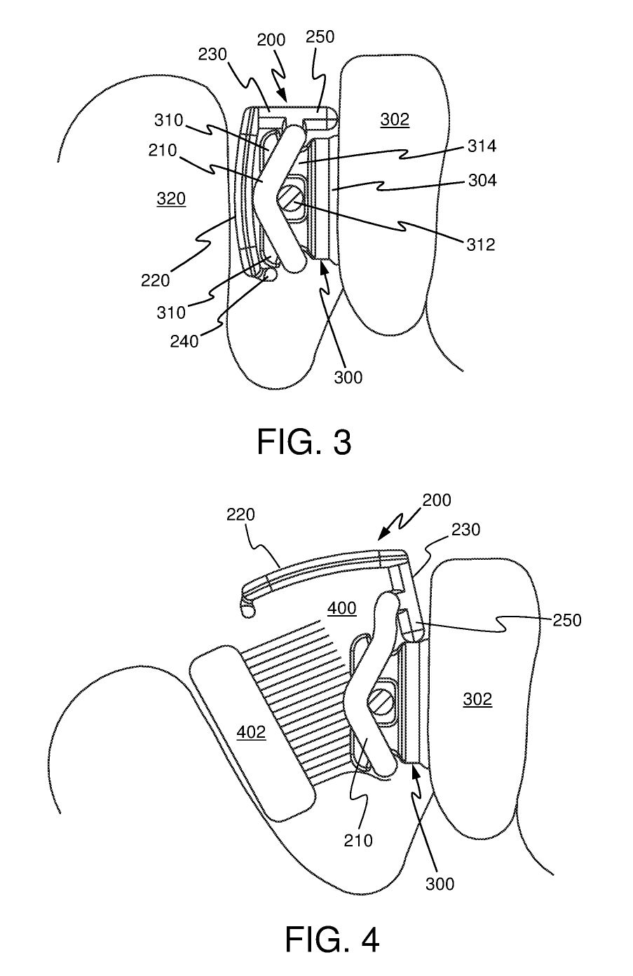

FIG. 3 illustrates a schematic illustration of an element, such as the element 200, for a dental bracket 300 in a used state, in accordance with an embodiment of the present disclosure. As shown, the dental bracket 300 is attached to a tooth 302 using orthodontic adhesive 304, such as dental cement. Further, the element 200 is attached to the dental bracket 300 using the ligature loop 210 of the element 200. Specifically, the ligature loop 210 securely conforms to tabs 310 of the dental bracket 300. Also, the ligature loop 210 enables in mounting an archwire 312 on the dental bracket 300, particularly, ligature loop 210 holds the archwire 312 into a slot 314 configured between the tabs 310. Therefore, the element 200, particularly, the cover section 220 of an element 200 is positioned adjacent to inner lip tissue 320. Further, the bridge section 230, particularly, the second protrusion 250 of the element 200 lie adjacent to the tooth 302. Moreover, the first protrusion 240 is shown to align with a bottom side of the dental bracket 300.

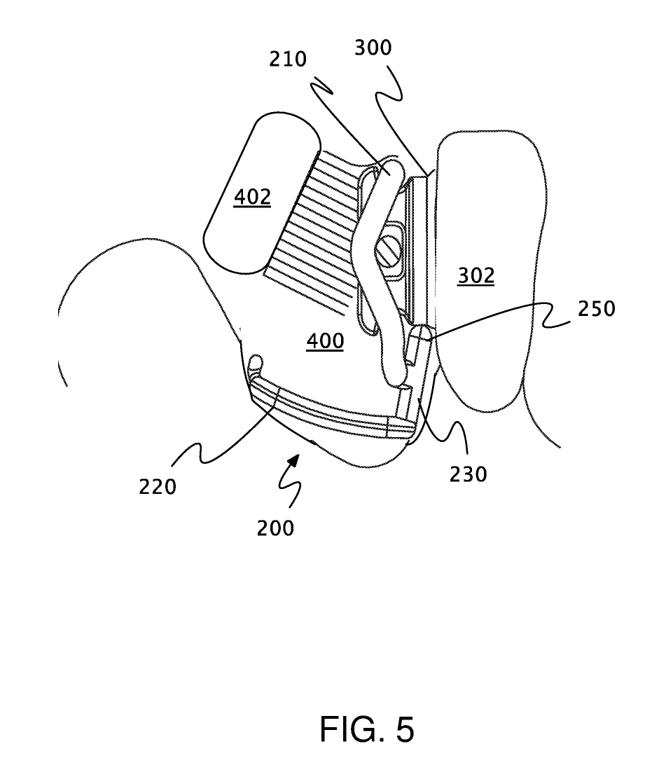

FIG. 4 and FIG. 5 illustrates a schematic illustration of the element 200 in the used state, in accordance with an embodiment of the present disclosure. As shown, the cover section 220 is pivotably moved away with respect to the dental bracket 300 for creating a space 400 therebetween. The space 400 allows a cleaning means 402, such as a tooth brush, to be received therein for enabling cleaning of the dental bracket 300. The cleaning means 402 can be further used for cleaning the ligature loop 210 and a portion, of the tooth 302, not covered by the dental bracket 300. The cleaning means 400 can be also used for cleaning the cover section 220, the bridge section 230 and the second protrusion 250, when the cover section 220 is resting on the dental bracket 300 (as shown in FIG. 3).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An element for a dental bracket, the element comprising:
a ligature loop;
a cover section having a first side and a second side, wherein the second side of the cover section faces the ligature loop, the cover section configured to have a size larger than the dental bracket and configured to completely envelop the dental bracket; and
a bridge section connecting the ligature loop and the cover section,
wherein the ligature loop and the cover section are arranged to pivot with respect to each other.

2. An element according to claim 1, wherein the ligature loop and the cover section are spaced apart and arranged to be parallel to each other.

3. An element according to claim 1, wherein each of the cover section and the bridge section comprises a first end and a second end, and wherein the first end of the bridge section is attached to the first end of the cover section and the second end of the bridge section is attached to the ligature loop.

4. An element according to claim 1, wherein the cover section comprises a first protrusion, the first protrusion protruding from the second side of the cover section at the second end of the cover section.

5. An element according to claim 1, wherein the bridge section comprises a second protrusion, the second protrusion protruding from the bridge section and perpendicular to the ligature loop.

6. An element according to claim 1, wherein the ligature loop is made of an elastic material, a plastic material or any combination thereof.

7. An element according to claim 1, wherein the cover section has one of a circular, an oval and a polygonal shape.

8. An element according to claim 1, wherein the cover section is configured to have a size smaller or equal to a tooth supporting the dental bracket.

9. Dental braces comprising at least one element according to claim 1.

10. Dental braces according to claim 9, further comprising an archwire adapted to be mounted on the dental bracket with the ligature loop.

11. An element according to claim 1, wherein the bridge section comprises a second protrusion protruding from a middle part of the bridge section to a position adjacent to a tooth supporting the dental bracket.

12. An element according to claim 11, wherein the second protrusion is arranged at an angle to the ligature loop, wherein the angle is different from 90 degrees.

13. An element according to claim 11, wherein the bridge section and the second protrusion collectively have a T-shape.
